(19) United States
(12) Patent Application Publication
(10) Pub. No.: US 2025/0388315 A1
(43) Pub. Date: Dec. 25, 2025

(54) DUCTED STRUCTURE, DUCTED FAN AND AIRCRAFT

(71) Applicant: NANJING UNIVERSITY OF AERONAUTICS AND ASTRONAUTICS, Nanjing (CN)

(72) Inventors: Chenkai CAO, Nanjing (CN); Wangqing ZHU, Nanjing (CN); Guoqing ZHAO, Nanjing (CN); Qijun ZHAO, Nanjing (CN); Xi CHEN, Nanjing (CN); Zhe CHEN, Nanjing (CN); Yifan LU, Nanjing (CN); Yangyang ZENG, Nanjing (CN)

(73) Assignee: NANJING UNIVERSITY OF AERONAUTICS AND ASTRONAUTICS, Nanjing (CN)

(21) Appl. No.: 19/242,914

(22) Filed: Jun. 18, 2025

(30) Foreign Application Priority Data
Jun. 20, 2024 (CN) 202410806794.4

(51) Int. Cl. B64C 11/00

(52) U.S. Cl. CPC B64C 11/001

(57) ABSTRACT

Provided is a ducted structure. The ducted structure includes a telescopic duct, a fixed cut and at least one duct driving device. The telescopic duct is slidably connected with the fixed duct, the fixed duct is fixedly connected with an aircraft body, and each duct driving device is fixedly connected with the fixed duct and is connected with the telescopic duct. The duct driving device can drive the telescopic duct to move back and forth along a central axis direction of the telescopic duct. A ducted fan is further provided, including a blade device and the ducted structure, and the blade device is arranged in a ducted cavity of the fixed duct. An aircraft is further provided, including an aircraft body and the ducted structure, and a fixed duct is fixedly connected with the aircraft body.

### CROSS-REFERENCE TO RELATED APPLICATION

This patent application claims the benefit and priority of Chinese Patent Application No. 202410806794.4, entitled “DUCTED STRUCTURE, DUCTED FAN AND AIRCRAFT” filed on Jun. 20, 2024, the disclosure of which is incorporated by reference herein in its entirety as part of the present application.

### TECHNICAL FIELD

The present disclosure relates to the technical field of aviation equipment, in particular to a ducted structure, a ducted fan and an aircraft.

### BACKGROUND

Ducted fan is a novel rotor structure for providing lift and thrust for a helicopter, an unmanned aerial vehicle and other aircrafts, which includes a ducted structure, a rotor and other structures, and the rotor is contained in a cylindrical ducted structure. In recent years, with rapid development of low-altitude economy, a large number of flying cars have emerged in the market. Flying car is a novel land-air transportation. To ensure overall flight efficiency of the flying car and safety of the rotor, the ducted structure is particularly important. Compared with a single open rotor, the ducted fan has higher overall aerodynamic efficiency and less rotor noise due to the presence of the ducted structure. In addition, the ducted structure can protect the rotor better.

However, if the ducted fan is to ensure sufficient upward thrust for hovering capability, the length of a duct must be sufficiently long. Yet during forward flight of the flying car, the presence of the duct increases the frontal area of the flying car. Excessive length of the duct leads to large frontal area during forward flight, which leads to excessive flight resistance and affect its overall efficiency. The existing ducted structure is of a cylindrical structure, and a length of the duct is non-adjustable. For example, according to a ducted fan provided in patent CN206943088U, a length of a duct cannot be adjusted according to a flight state (hovering state or forward flight state), leading to low overall efficiency of flight.

### SUMMARY

The embodiments aim to provide a ducted structure, a ducted structure and an aircraft to solve the problems in the prior art, which can adapt to requirements of the aircraft under different working conditions, thereby improving the overall efficiency.

To achieve the objective above, the present disclosure provides the following technical solutions.

The present disclosure provides a ducted structure, including a telescopic duct, a fixed duct and at least one duct driving device. The at least one telescopic duct is slidably connected with the fixed duct. The fixed duct is configured to be fixedly connected with an aircraft body. Each of the at least one duct driving device is fixedly connected with the fixed duct and is connected with the telescopic duct. The at least one duct driving device is able to drive the telescopic duct to move back and forth along a central axis direction of the telescopic duct.

In some embodiments, one end of the fixed duct is provided with a mounting groove. All the at least one duct driving device is arranged in the mounting groove. An outer sidewall of the telescopic duct is able to be slidably connected with an inner sidewall of the mounting groove.

In some embodiments, the telescopic duct includes a duct body and at least one protrusion. Each of the at least one protrusion is fixedly connected with the duct body and protrudes from an outer sidewall of the duct body. The inner sidewall of the mounting groove is provided with at least one chute. Each of the at least one protrusion is in fit with one of the at least one chute and is slidably connected with a corresponding one of the at least one at least one chute.

In some embodiments, each of the at least one protrusion includes a first protrusion and a second protrusion. Two ends of the first protrusion are fixedly connected with the duct body and one second protrusion, respectively. At least one end of the second protrusion protrudes from an outer sidewall of a corresponding first protrusion. Each of the at least one chute includes a first chute and a second chute that communicate with each other. The first chute communicates with the mounting groove. The first protrusion is in fit with one first chute and is slidably connected with a corresponding first chute. The second protrusion is in fit with one second chute and is slidably connected with a corresponding second chute.

In some embodiments, each of the at least one duct driving devices is a linear motor.

The present disclosure further provides a ducted fan, including a blade device and the ducted structure, and the blade device is arranged in a ducted cavity of a fixed duct.

In some embodiments, the ducted fan further includes a central body. The central body includes a first central body and a second central body. The blade device includes a blade driving device and a rotor blade assembly. The central body is at least partially arranged in the ducted cavity. The first central body is fixedly connected with the fixed duct. The second central body is rotatably connected with the first central body. The rotor blade assembly is fixedly connected with the second central body. The blade driving device is fixedly connected with the first central body and is connected with the second central body. The blade driving device is able to drive the second central body to rotate around a central axis of the ducted cavity.

The present disclosure further provides an aircraft, including an aircraft body and the ducted structure, where a fixed duct is fixedly connected with the aircraft body.

Compared with the prior art, the embodiments have the following technical effects.

A ducted structure, a ducted fan and an aircraft are provided. This embodiment provides a ducted structure, including a telescopic duct, a fixed duct and at least one duct driving device. The telescopic duct is slidably connected with the fixed duct, each duct driving device is connected with the telescopic duct, and the duct driving device can drive the telescopic duct to move back and forth along a central axis direction of the telescopic duct. According to a flight state of the aircraft, the telescopic duct is driven by the duct driving device to extend and retract along a central axis direction of the telescopic duct, and a length of the duct can be changed to meet requirements of the aircraft under different working conditions. Specifically, when the aircraft is in a hovering state, the telescopic duct can be driven by the duct driving device to extend outward to increase the length of the ducted structure, preferably, the ducted structure is increased to a maximum length to ensure that the ducted fan can pull up the whole aircraft successfully. When the aircraft is in a forward flight state, the telescopic duct is driven by the duct driving device to retract inward to reduce the length of the ducted structure, preferably, the ducted structure is reduced to a minimum length to reduce a frontal area of the aircraft, thereby reducing overall resistance and improving overall efficiency.

### BRIEF DESCRIPTION OF THE DRAWINGS

To describe the technical solutions of the embodiments of the present disclosure or in the prior art more clearly, the following briefly introduces the drawings required for describing the embodiments. Apparently, the drawings in the following description show merely some embodiments of the present disclosure, and those of ordinary skill in the art may still derive other drawings from these drawings without creative efforts.

FIG. 1 is a structural diagram of a ducted structure according to Embodiment I;

FIG. 2 is a structural diagram of a fixed duct according to Embodiment I;

FIG. 3 is a sectional diagram of a mounting groove according to Embodiment I;

FIG. 4 is a structural diagram of a ducted structure according to Embodiment II;

FIG. 5 is a front view of a fixed duct according to Embodiment II;

FIG. 6 is a bottom view of FIG. 5;

FIG. 7 is a top view of FIG. 6;

FIG. 8 is a structural diagram of a ducted fan according to Embodiment II without a telescopic duct;

FIG. 9 is an enlarged view of A in FIG. 8;

FIG. 10 is a structural diagram of the ducted fan according to Embodiment II without the fixed duct;

FIG. 11 is an enlarged view of B in FIG. 10; and

FIG. 12 is a diagram of inward retraction of the telescopic duct according to Embodiment II.

List of the reference characters: 100 ducted structure; 200 ducted fan; 1 telescopic duct; 2 fixed duct; 201 mounting groove; 202 ducted cavity; 3 duct driving device; 4 first protrusion; 5 second protrusion; 6 first chute; 7 second chute; 8 first central body; 9 second central body; 10 ducted stator; and 11 rotor blade.

### DETAILED DESCRIPTION OF THE EMBODIMENTS

The following clearly and completely describes the technical solutions in the embodiments of the present disclosure with reference to the drawings in the embodiments of the present disclosure. Apparently, he described embodiments are merely a part rather than all of the embodiments of the present disclosure. All other embodiments obtained by those of ordinary skill in the art based on the embodiments of the present disclosure without creative efforts shall fall within the protection scope of the present disclosure.

The embodiments aim to provide a ducted structure, a ducted structure and an aircraft to solve the problems in the prior art, which can adapt to requirements of the aircraft under different working conditions, thereby improving overall efficiency.

To make the foregoing objectives, features and advantages of the present disclosure more clearly, the present disclosure is further described in detail below with reference to drawings and specific embodiments.

### Embodiment I

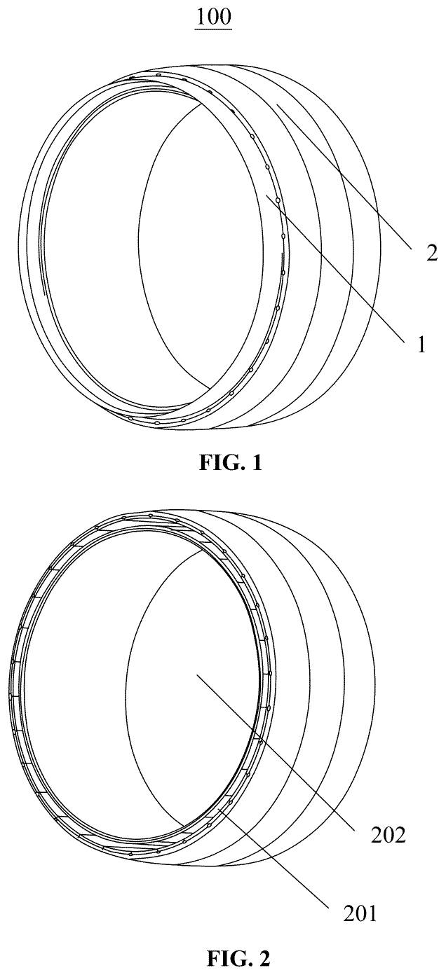

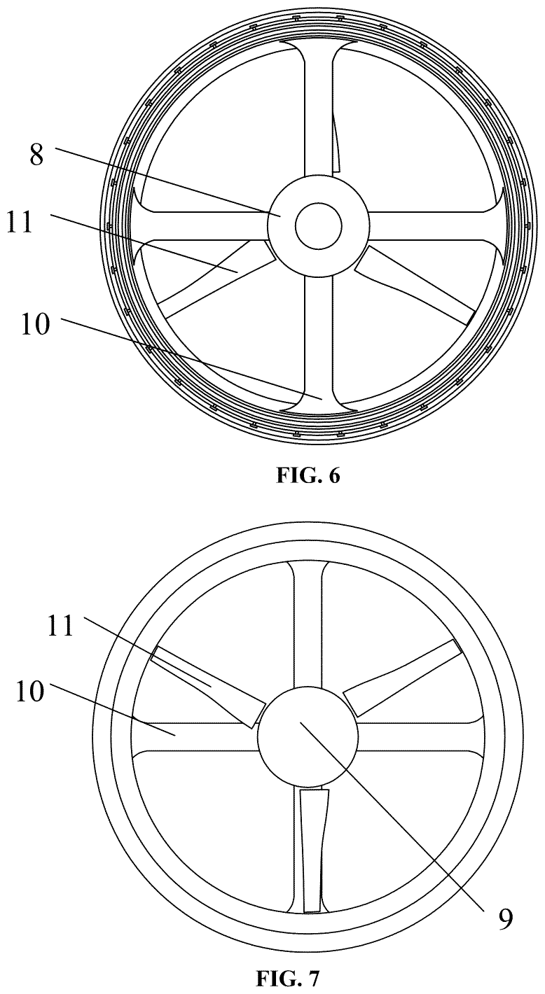

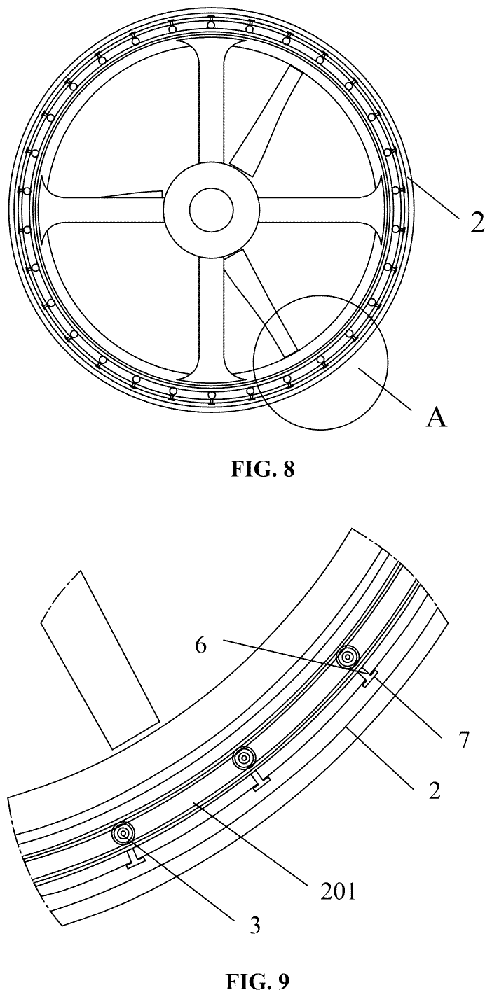

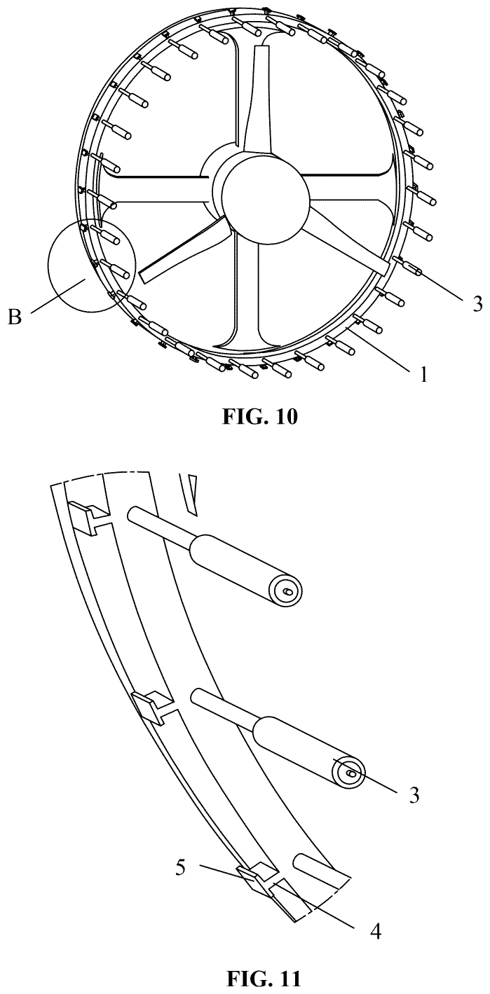

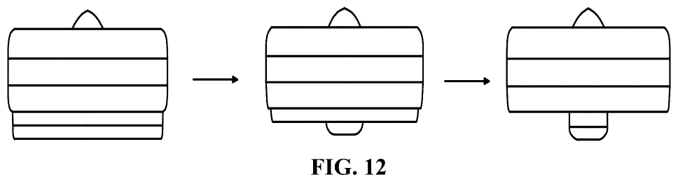

As shown in FIG. 1 to FIG. 12, this embodiment provides a ducted structure 100, including a telescopic duct 1, a fixed duct 2 and at least one duct driving device 3. The telescopic duct 1 is slidably connected with the fixed duct 2, the fixed duct 2 is fixedly connected with an aircraft body, each duct driving device 3 is fixedly connected with the fixed duct 2 and is connected with the telescopic duct 1, and the duct driving device 3 can drive the telescopic duct 1 to move back and forth in a central axis direction of the telescopic duct 1. According to a flight state of the aircraft, the telescopic duct 1 is driven by the duct driving device 3 to extend and retract along a central axis direction of the telescopic duct 1, and a length of the duct can be changed to meet requirements of the aircraft under different working conditions. Specifically, when the aircraft is in a hovering state, the telescopic duct 1 can be driven by the duct driving device 3 to extend outward to increase the length of the ducted structure 100, preferably, the ducted structure 100 is increased to a maximum length to ensure that the ducted fan 200 can pull up the whole aircraft successfully. When the aircraft is in a forward flight state, the telescopic duct 1 is driven by the duct driving device 3 to retract inward to reduce the length of the ducted structure 100, preferably, the ducted structure 100 is reduced to a minimum length to reduce a frontal area of the aircraft, thereby reducing overall resistance and improving overall efficiency.

As a preferred embodiment, the ducted structure further includes a controller, and the controller is in signal connection with the duct driving device 3. During hovering, a duct outward extending signal is sent by the controller to the duct driving device 3, and the telescopic duct 1 is driven by the duct driving device 3 to extend outward. When flying forward, a duct inward retraction signal is sent by the controller to the duct driving device 3, the telescopic duct 1 is driven by the duct driving device 3 to retract inward, thereby achieving free length change of the duct.

In this embodiment, one end of the fixed duct 2 is provided with a mounting groove 201, all duct driving devices 3 are arranged in the mounting groove 201, and an outer sidewall of the telescopic duct 1 can be slidably connected with an inner sidewall of the mounting groove 201.

As shown in FIG. 8 to FIG. 11, in this embodiment, the telescopic duct 1 includes a duct body and at least one protrusion. Each protrusion is fixedly connected with the duct body, and protrudes from an outer sidewall of the duct body. The inner sidewall of the mounting groove 201 is provided with at least one chute, each protrusion is in fit with one chute, and each protrusion is slidably connected with the corresponding chute. The chute can limit a motion of the corresponding protrusion along a circumferential direction of the fixed duct 2. The protrusion is in sliding fit with the chute, such that the telescopic duct 1 can move back and forth along the central axis direction of the telescopic duct 1 smoother.

As shown in FIG. 8 to FIG. 11, in this embodiment, each protrusion includes a first protrusion 4 and a second protrusion 5, two ends of each first protrusion 4 are fixedly connected with the duct body and one second protrusion 5, respectively. At least one end of each second protrusion 5 protrudes from an outer sidewall of the corresponding first protrusion 4. Each chute includes a first chute 6 and a second chute 7 that communicate with each other, and each first chute 6 communicates with the mounting groove 201. Each first protrusion 4 is in fit with one first chute 6 and is slidably connected with the corresponding first chute 6. Each second protrusion 5 is in fit with one second chute 7 and is slidably connected with the corresponding second chute 7. As a preferred embodiment, the protrusion and the chute are both T-shaped.

In this embodiment, each duct driving device 3 is a linear motor, an output end of the duct driving device 3 is fixedly connected with the telescopic duct 1, and the other end of the duct driving device 3 is fixedly connected with the fixed duct 2. Preferably, there are multiple duct driving devices 3. More preferably, there are thirty duct driving devices 3. The mounting groove is an annular groove, and all duct driving devices 3 are uniformly distributed along a circumferential direction of the annular groove.

### Embodiment II

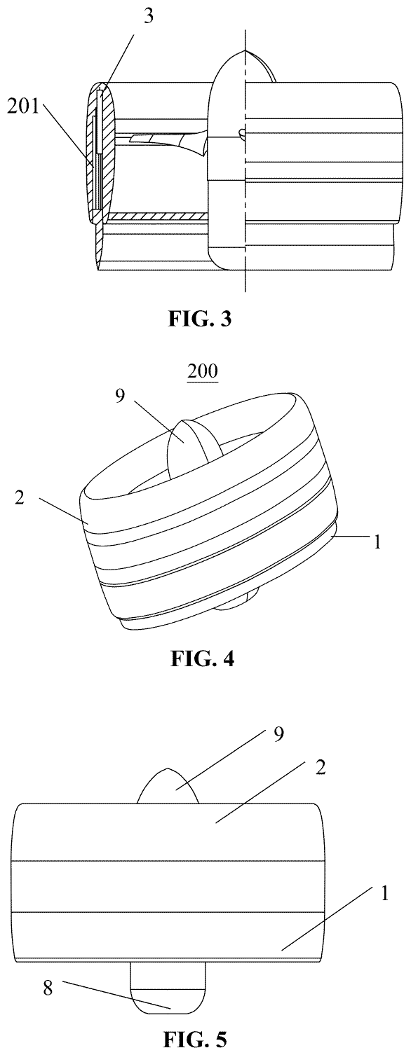

As shown in FIG. 3 to FIG. 12, this embodiment further provides a ducted fan 200, including a blade device and the ducted structure 100 in Embodiment I. The blade device is arranged in a ducted cavity 202 of the fixed duct 2.

As shown in FIG. 4 to FIG. 7, in this embodiment, the ducted fan further includes a central body. The central body includes a first central body 8 and a second central body 9. The blade device includes a blade driving device and a rotor blade assembly. The central body is at least partially arranged in the ducted cavity 202. The first central body 8 is fixedly connected with the fixed duct 2. The second central body 9 is rotatably connected with the first central body 8. The rotor blade assembly is fixedly connected with the second central body 9. The blade driving device is fixedly connected with the first central body 8. The blade driving device is connected with the second central body 9. The blade driving device can drive the second central body 9 to rotate around a central axis of the ducted cavity 202, thereby driving the rotor blade assembly to rotate around a central axis of the ducted cavity 202. The central body can play a role of fixing and supporting the rotor blade assembly. The blade driving device and the like. The blade driving device can drive the rotor blade assembly to rotate rapidly when the aircraft flies, and the rotor blade assembly is a main power source of the ducted fan 200.

As a preferred embodiment, the ducted fan further includes at least one ducted stator 10. Two ends of each ducted stator 10 are fixedly connected with an outer sidewall of the first central body 8 and an inner sidewall of the fixed duct 2, respectively. The rotor blade assembly includes at least two rotor blades 11. One end of each rotor blade 11 is fixedly connected with the outer sidewall of the second central body 9, and the other end of each rotor blade 11 extends in a direction away from the second central body 9. Multiple ducted stators 10 and multiple rotor blades 11 are provided, the multiple ducted stators 10 are arranged along a circumferential direction of the first central body 8, and the multiple rotor blades 11 are arranged along a circumferential direction of the second central body 9.

### Embodiment III

The present disclosure further provides an aircraft, including an aircraft body and the ducted structure 100 in Embodiment I. The fixed duct 2 is fixedly connected with the aircraft body.

The aircraft in this embodiment is preferably a flying car, but is not limited thereto, and may also be an unmanned aerial vehicle and other aircrafts.

Specific examples are used herein for illustration of the principles and embodiments of the present disclosure. The description of the embodiments is merely used to help illustrate the method and its core principles of the present disclosure. In addition, those of ordinary skill in the art can make various modifications in terms of specific embodiments and scope of application in accordance with the teachings of the present disclosure. In conclusion, the content of this specification shall not be construed as a limitation to the present disclosure.

1-8. (canceled)

9. A ducted structure, comprising:
a telescopic duct, a fixed duct and at least one duct driving device, wherein the at least one telescopic duct is slidably connected with the fixed duct, the fixed duct is configured to be fixedly connected with an aircraft body, each of the at least one duct driving device is fixedly connected with the fixed duct and is connected with the telescopic duct, and the at least one duct driving device is able to drive the telescopic duct to move back and forth along a central axis direction of the telescopic duct;
one end of the fixed duct is provided with a mounting groove, all the at least one duct driving device is arranged in the mounting groove, and an outer sidewall of the telescopic duct is able to be slidably connected with an inner sidewall of the mounting groove;
the telescopic duct comprises a duct body and at least one protrusion, each of the at least one protrusion is fixedly connected with the duct body and protrudes from an outer sidewall of the duct body, the inner sidewall of the mounting groove is provided with at least one chute, each of the at least one protrusion is in fit with one of the at least one chute and is slidably connected with a corresponding one of the at least one at least one chute;
each of the at least one protrusion comprises a first protrusion and a second protrusion, two ends of the first protrusion are fixedly connected with the duct body and one second protrusion, respectively, at least one end of the second protrusion protrudes from an outer sidewall of a corresponding first protrusion; each of the at least one chute comprises a first chute and a second chute that communicate with each other, and the first chute communicates with the mounting groove; the first protrusion is in fit with one first chute and is slidably connected with a corresponding first chute; and the second protrusion is in fit with one second chute and is slidably connected with a corresponding second chute.

10. The ducted structure according to claim 9, wherein each of the at least one duct driving device is a linear motor.

11. A ducted fan, comprising:
a blade device, and
a ducted structure comprising
a telescopic duct, a fixed duct and at least one duct driving device, wherein the at least one telescopic duct is slidably connected with the fixed duct, the fixed duct is configured to be fixedly connected with an aircraft body, each of the at least one duct driving device is fixedly connected with the fixed duct and is connected with the telescopic duct, and the at least one duct driving device is able to drive the telescopic duct to move back and forth along a central axis direction of the telescopic duct;
one end of the fixed duct is provided with a mounting groove, all the at least one duct driving device is arranged in the mounting groove, and an outer sidewall of the telescopic duct is able to be slidably connected with an inner sidewall of the mounting groove;
the telescopic duct comprises a duct body and at least one protrusion, each of the at least one protrusion is fixedly connected with the duct body and protrudes from an outer sidewall of the duct body, the inner sidewall of the mounting groove is provided with at least one chute, each of the at least one protrusion is in fit with one of the at least one chute and is slidably connected with a corresponding one of the at least one at least one chute;
each of the at least one protrusion comprises a first protrusion and a second protrusion, two ends of the first protrusion are fixedly connected with the duct body and one second protrusion, respectively, at least one end of the second protrusion protrudes from an outer sidewall of a corresponding first protrusion; each of the at least one chute comprises a first chute and a second chute that communicate with each other, and the first chute communicates with the mounting groove; the first protrusion is in fit with one first chute and is slidably connected with a corresponding first chute; and the second protrusion is in fit with one second chute and is slidably connected with a corresponding second chute,
wherein the blade device is arranged in a ducted cavity of the fixed duct.

12. The ducted fan according to claim 11, further comprising a central body, wherein the central body comprises a first central body and a second central body, the blade device comprises a blade driving device and a rotor blade assembly, the central body is at least partially arranged in the ducted cavity, the first central body is fixedly connected with the fixed duct, the second central body is rotatably connected with the first central body, the rotor blade assembly is fixedly connected with the second central body, the blade driving device is fixedly connected with the first central body and is connected with the second central body, and the blade driving device is able to drive the second central body to rotate around a central axis of the ducted cavity.

13. The ducted fan according to claim 11, wherein each of the at least one duct driving device is a linear motor.

14. The ducted fan according to claim 13, further comprising a central body, wherein the central body comprises a first central body and a second central body, the blade device comprises a blade driving device and a rotor blade assembly, the central body is at least partially arranged in the ducted cavity, the first central body is fixedly connected with the fixed duct, the second central body is rotatably connected with the first central body, the rotor blade assembly is fixedly connected with the second central body, the blade driving device is fixedly connected with the first central body and is connected with the second central body, and the blade driving device is able to drive the second central body to rotate around a central axis of the ducted cavity.

15. An aircraft, comprising:
an aircraft body; and
a ducted structure comprising
a telescopic duct, a fixed duct and at least one duct driving device, wherein the at least one telescopic duct is slidably connected with the fixed duct, the fixed duct is configured to be fixedly connected with an aircraft body, each of the at least one duct driving device is fixedly connected with the fixed duct and is connected with the telescopic duct, and the at least one duct driving device is able to drive the telescopic duct to move back and forth along a central axis direction of the telescopic duct;
one end of the fixed duct is provided with a mounting groove, all the at least one duct driving device is arranged in the mounting groove, and an outer sidewall of the telescopic duct is able to be slidably connected with an inner sidewall of the mounting groove;
the telescopic duct comprises a duct body and at least one protrusion, each of the at least one protrusion is fixedly connected with the duct body and protrudes from an outer sidewall of the duct body, the inner sidewall of the mounting groove is provided with at least one chute, each of the at least one protrusion is in fit with one of the at least one chute and is slidably connected with a corresponding one of the at least one at least one chute;
each of the at least one protrusion comprises a first protrusion and a second protrusion, two ends of the first protrusion are fixedly connected with the duct body and one second protrusion, respectively, at least one end of the second protrusion protrudes from an outer sidewall of a corresponding first protrusion; each of the at least one chute comprises a first chute and a second chute that communicate with each other, and the first chute communicates with the mounting groove; the first protrusion is in fit with one first chute and is slidably connected with a corresponding first chute; and the second protrusion is in fit with one second chute and is slidably connected with a corresponding second chute;
wherein the fixed duct is fixedly connected with the aircraft body.

16. The aircraft according to claim 15, wherein each of the at least one duct driving device is a linear motor.
